(19) United States
(12) Patent Application Publication
(10) Pub. No.: US 2010/0040293 A1
(43) Pub. Date: Feb. 18, 2010

(54) Kinematic Based Authentication

(75) Inventors: Reto Josef Hermann, Buttikon (CH); Dirk Husemann, Einsiedeln (CH); Andreas Schade, Langnau am Albis (CH)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 12/190,098

(22) Filed: Aug. 12, 2008

(51) Int. Cl. G06K 9/68

(52) U.S. Cl. 382/218

(57) ABSTRACT

In one embodiment, a computer-implemented method for authentication by kinematic pattern match is provided. The computer implemented method prompts a user for a kinematic input, receives an element of a kinematic pattern to form a set of received elements, and determines whether there are additional elements of the kinematic pattern. Responsive to a determination that there are no additional elements of the kinematic pattern, forms a kinematic pattern from the set of received elements and computes a signature from the set of received elements. The computer implemented method further determines whether the signature matches a predetermined value, and responsive to a determination that the signature matches a predetermined value, sends an authentication signal.

### BACKGROUND OF THE INVENTION

1. Field of the Invention

The present invention relates generally to an improved data processing system and, more specifically, to a computer-implemented method, a data processing system and a computer program product for kinematic based authentication.

2. Description of the Related Art

Authentication is a service related to identification, whereby two parties entering into a relationship identify each other. The term party is used here in a very broad sense including human users, roles, devices, and other entities. Authentication proves the authenticity of the identity of party to another party and is typically based on any combination of the following classes of proofs; of knowing something, having something; and being something.

The first class describes the method whereby authentication is based on proving knowledge of a secret uniquely associated with a party. The second class describes a method whereby authentication is based on proving possession of a physical item, such as a key or a token. The third class describes a method whereby authentication is based on presenting biometric information as the proof.

Authentication procedures are commonplace and are regularly performed. For instance, authorization of e-payments at the point-of-sale terminal, cash withdrawal at the automated teller machine, starting a car, or presenting a ticket at the entrance to a theater are all acts of authentication.

Users typically want to authenticate themselves towards a device and, thus, indirectly towards any other party that trusts said device, based on proving knowledge of a secret. Authentication based on something one “knows” requires a modality by which the knowledge can be expressed and sensed. Human users can express themselves in a variety of ways, including mechanical (keyboard, personal identification number (PIN) pad, touch screen), acoustic (microphone), optical (camera), and olfactory (although difficult to supply with subtle meaning).

In situations where devices are very small, such as players supporting the industry standard motion picture expert group-1 audio layer 3 (MP3) format and universal serial bus memory sticks, universal serial bus sticks with other functionality, security tokens, etc., the mere size of these devices prevents the use of the mentioned mechanical or optical input devices on the device itself and, thus, eliminates the possibility of all authentication methods that depend on them. Microphones, while small, could be built into the class of devices, but suffer from the weakness of simple record/replay attacks. Chemical noses, while also small, are not practical because users cannot willingly control respective expression to the level of detail necessary for identification. Thus, there is a need to satisfy authentication requirements when using devices having small footprints.

### BRIEF SUMMARY OF THE INVENTION

According to one embodiment of the present invention, a computer-implemented method for authentication by kinematic pattern match is provided. The computer implemented method prompts a user for a kinematic input, receives an element of a kinematic pattern to form a set of received elements, and determines whether there are additional elements of the kinematic pattern. Responsive to a determination that there are no additional elements of the kinematic pattern, forms a kinematic pattern from the set of received elements and computes a signature from the set of received elements. The computer implemented method further determines whether the signature matches a predetermined value, and responsive to a determination that the signature matches a predetermined value, sends an authentication signal

### BRIEF DESCRIPTION OF THE SEVERAL VIEWS OF THE DRAWINGS

FIG. 1 is block diagram of a data processing environment in which illustrative embodiments may be implemented;

FIG. 2 is a block diagram of a kinematic authentication system, in accordance with illustrative embodiments;

FIG. 3 is a block diagram of a kinematic authenticator, in accordance with illustrative embodiments;

FIG. 4 is a block diagram of a kinematic authentication process, in accordance with illustrative embodiments;

FIG. 5 is a flowchart of a kinematic authentication training process, in accordance with illustrative embodiments; and

FIG. 6 is a flowchart of a kinematic authentication process, in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wire line, optical fiber cable, RF, etc.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products, according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus, to produce a machine, such that the instructions, which execute via the processor of the computer, or other programmable data processing apparatus, create means for implementing the functions/acts specified in the flowchart and/or block diagram block or blocks. These computer program instructions may also be stored in a computer-readable medium that can direct a computer, or other programmable data processing apparatus, to function in a particular manner, such that the instructions stored in the computer-readable medium produce an article of manufacture including instruction means which implement the function/act specified in the flowchart and/or block diagram block or blocks.

The computer program instructions may also be loaded onto a computer, or other programmable data processing apparatus, to cause a series of operational steps to be performed on the computer, or other programmable apparatus, to produce a computer implemented process, such that the instructions which execute on the computer, or other programmable apparatus, provide processes for implementing the functions/acts specified in the flowchart and/or block diagram block or blocks.

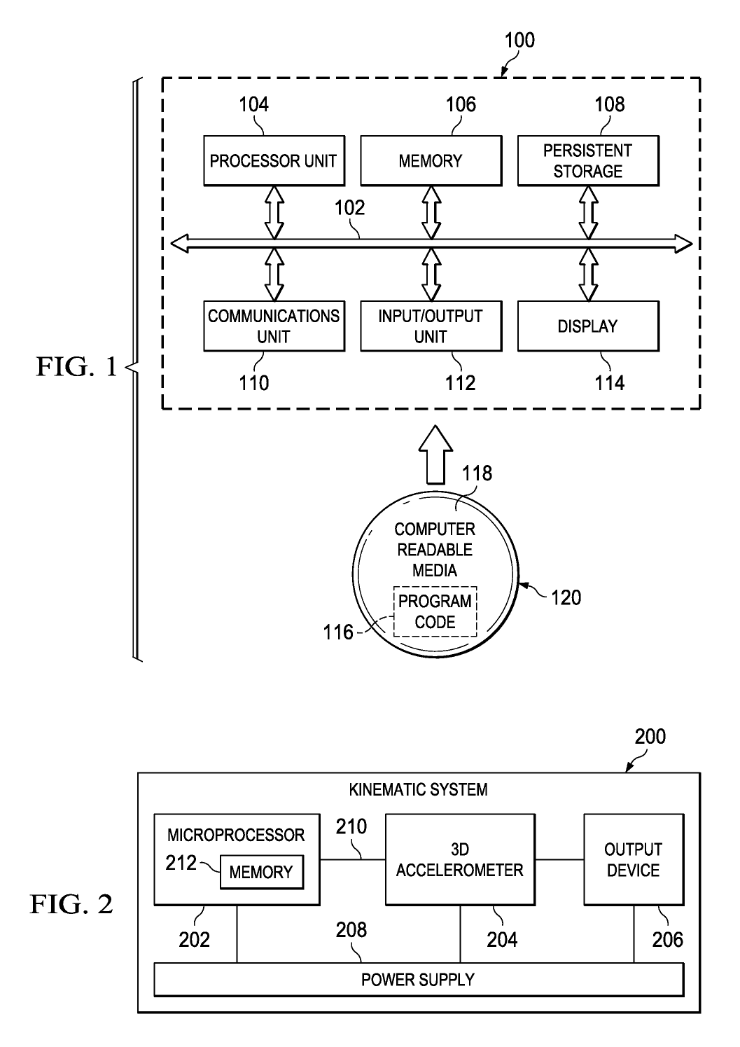

With reference now to the figures and in particular with reference to FIG. 1, an exemplary diagram of a data processing environment is provided in which illustrative embodiments may be implemented. It should be appreciated that FIG. 1 is only exemplary and not intended to assert or imply any limitation with regard to the environments in which different embodiments may be implemented. Many modifications to the depicted environment may be made.

FIG. 1 depicts a block diagram of a data processing system is shown, in which illustrative embodiments may be implemented. Data processing system 100 is an example of a computer, in which computer-usable program code, or instructions implementing the processes, may be located for the illustrative embodiments. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices. A storage device is any piece of hardware that is capable of storing information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard and mouse. Further, input/output unit 112 may send output to a printer. Display 114 provides a mechanism to display information to a user.

Instructions for the operating system and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106. These instructions are referred to as program code, computer-usable program code, or computer-readable program code that may be read and executed by a processor in processor unit 104. The program code in the different embodiments may be embodied on different physical or tangible computer-readable media, such as memory 106 or persistent storage 108.

Program code 116 is located in a functional form on computer-readable media 118 that is selectively removable and may be loaded onto or transferred to data processing system 100 for execution by processor unit 104. Program code 116 and computer-readable media 118 form computer program product 110 in these examples. In one example, computer-readable media 118 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer-readable media 118 also may take the form of a persistent storage, such as a hard drive, a thumb drive, or a flash memory that is connected to data processing system 100. The tangible form of computer-readable media 118 is also referred to as computer-recordable storage media. In some instances, computer-readable media 118 may not be removable.

Alternatively, program code 116 may be transferred to data processing system 100 from computer-readable media 118 through a communications link to communications unit 110 and/or through a connection to input/output unit 112. The communications link and/or the connection may be physical or wireless in the illustrative examples. The computer-readable media also may take the form of non-tangible media, such as communications links or wireless transmissions containing the program code. The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. As one example, a storage device in data processing system 100 is any hardware apparatus that may store data. Memory 106, persistent storage 108, and computer-readable media 118 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

With reference to FIG. 2, a block diagram of a kinematic authentication system, in accordance with illustrative embodiments. In the simplified diagram, kinematic system 200 contains a number of components comprising microprocessor 202, 3D accelerometer 204, output device 206, power supply 208, digital connector 210 and memory 212. Kinematic system 200 may be configured as a standalone device or connected to system 100 of FIG. 1 typically by way of a wired or wireless connection with communications fabric 102, communications unit 110, or input/output (I/O) unit 112. A wired connection may be used when providing sufficient operation flexibility to supply the required input gestures.

For example, using system 100 of FIG. 1, a computer implemented method for authentication by kinematic pattern match is provided. System 200 may be connected to system 100 by communication fabric 102, communication unit 110 or input/output unit 112, using typical connectors such as universal serial bus, wireless or wired components. The computer implemented method prompts a user for a kinematic input captured by 3D accelerometer 204, receives an element of a kinematic pattern to form a set of received elements, and microprocessor 202 determines whether there are additional elements of the kinematic pattern. Responsive to a determination that there are sufficient elements to generate a signature from the set of received elements, computes a signature from the set of received elements. When in a training mode the generated signature would be stored to form a predetermined value. The computer implemented method further determines whether the generated signature matches a predetermined value that may be stored in persistent storage 108, and responsive to a determination that the signature matches a predetermined value, sends an authentication signal using output device 206.

Microprocessor 202 in combination with memory 212 provides the processing capability necessary to compute data received from 3D accelerometer 204. Microprocessor 202 executes methods to be described. The results are provided to output device 206. Output device may be a visual or audio type device as needed to provide feedback to a user. For example output device 206 may be a simple light-generating element, such as a light emitting diode, or a full function display or a speaker coupled to a buzzer, dependent upon the usage requirements.

Power supply 208 provides sufficient power to enable the suitable operation of all components. Power supply 208 may also be a connection to system 200, such as a universal serial bus connection providing communication and power signals between devices.

3D accelerometer 204 provides the motion capture element of the system. The device is capable of measuring and capturing dynamic motion and static (gravitational) acceleration in three dimensions in real time, and transformed into digital input that is sent over digital connector 210 to microprocessor 202 and memory 212. The motion captured includes tapping or waving gestures in the air to produce motion patterns such as a sequence of hand movements. The movements are captured, analyzed and compared with a stored pattern as part of an authentication process.

In one embodiment, an authentication method is presented that is based on kinematics, a variation of the mechanical modality. Users are typically very good at remembering complex patterns of motion that may represent a signature, with subtle features. 3D-accelerometer 204 is built into the device of kinematic system 200, towards which authentication takes place. During a training phase, the user teaches kinematic system 200 a signature, by repeatedly making the same gestures, as a kinematic pattern in space with a hand holding the device. The device learns the signature of the authenticating user. During a subsequent operation, the user replicates the same gesture to prove authenticity. Assuming non-trivial motion patterns, which user feedback during the training phase prevents, an observer typically has difficulty in copying the signature motion pattern.

Copying the motion pattern is typically far more difficult than reproducing a handwritten signature, because the motion is three-dimensional and the signature is formed by accelerations, not just the resulting trajectory. The illustrative embodiment provides a feature of being compact in that the input modality enables authentication towards devices not previously supported, being robust requiring neither openings nor movable parts on the device and cost effective due to advances in micro-electronic mechanical systems (MEMS) technology, using three dimension accelerometers that start to meet the price points of mass market gadgets.

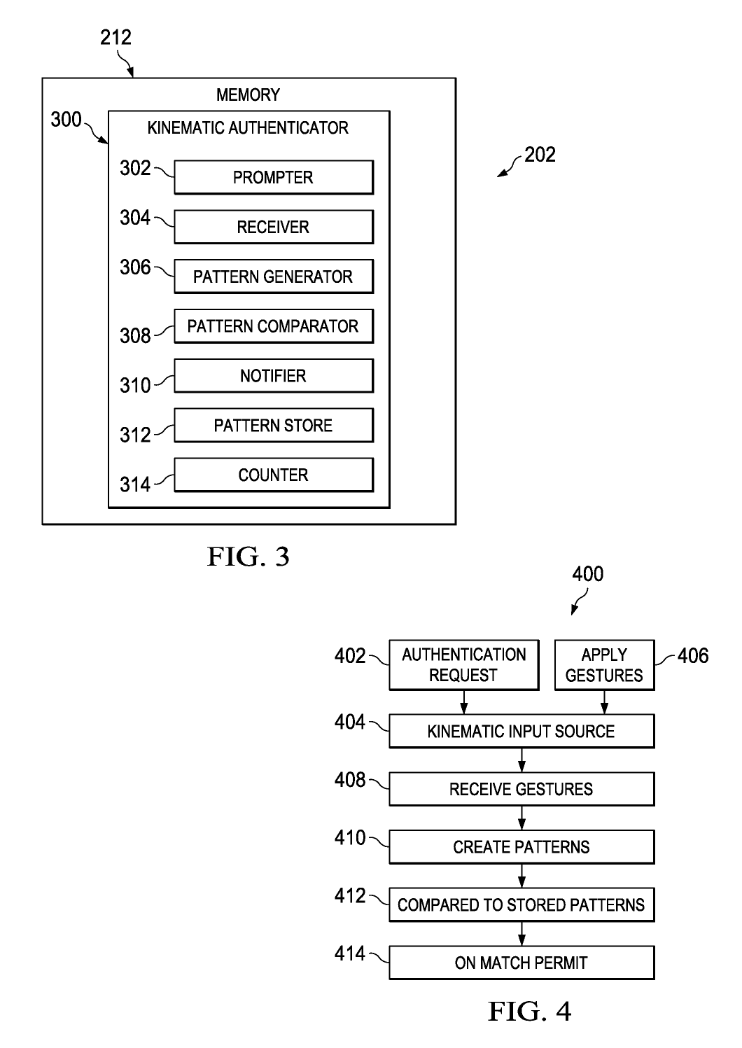

With reference to FIG. 3, a block diagram of a kinematic authenticator, in accordance with illustrative embodiments, is shown. Kinematic authenticator 300 is shown in further detail within microprocessor 202 and memory 212 of system 200. Kinematic authenticator 300 contains a number of components comprising prompter 302, receiver 304, signature generator 306, pattern comparator 308, notifier 310, pattern store 312, counter 314, and probabilistic analyzer 316.

Prompter 302 communicates with output device 206 of system 200 of FIG. 2 to provide feedback to a user in an audio or visual form. Receiver 304 receives signals via digital connector 210. Signature generator 306 receives the digital input and assembles the digitized motions into a set of pattern elements. Probabilistic analyzer 316 judges the strength of the gestures based on probabilistic analysis of the kinematic motion pattern as part of the digitizing process. When a set of pattern elements is complete or sufficient, a signature is generated from the series of motion patterns.

Pattern comparator 308 provides a capability to analyze or compare a collected pattern of the current signature with a pattern of the stored signature maintained in pattern store 312. A predefined number of tries or attempts may be allowed to produce a matching signature, with counter 314 tracking the number of attempts. When a number of attempts exceed a threshold, the device typically prevents further attempts and notifies the user. A user is authenticated when a match of the signatures is realized. The result of the authentication is made known to the user by notifier 310. Notifier 310 communicates with output device 206 to create an audio or visual output.

With reference to FIG. 4, a block diagram of a kinematic authentication process, in accordance with illustrative embodiments, is shown. Authentication process 400 is initiated by authentication request 402 provided to kinematic input source 404. A requesting user creates apply gestures 406 which are then received gestures 408 by the device. Received gestures 408 enables the device to create signatures 410 which can then be compared to stored signature patterns 412. On determining the occurrence of a match, on match permit 414 or successful authentication of the user is made.

In an illustrative embodiment, input may be performed differently, such as by pressing a button. Similarly, device output actions could be performed differently with the availability of other output modes, such as liquid crystal display. User input to the device is accomplished by motions of the device in the form of three basic motion types or apply gestures 406 of a turn, a knock, and a move, as measured by 3D accelerometer 204 of FIG. 2.

A turn is where kinematic input source 404 is turned upside down, creating a change in static acceleration based on gravitation along one axis, nominally axis z. A knock occurs when kinematic input source 404 is knocked against a surface, creating sudden changes in dynamic acceleration along several axes of x, y, z. Input messages with different semantics are possible via distinct knocking patterns. A move occurs when the device is moved in three dimensional-space describing a distinct kinematic motion pattern, resulting in acceleration values along the three axes x, y, z.

Motion types or apply gestures 406 may be used as a command. A set sequence of turn and knock may be used to convey messages to kinematic input source 404 to condition the device for certain actions. For example, a sequence {turn, knock, knock, knock} could be used to signal the starting of a training phase to the device. A move command is used exclusively to describe a user signature to be used for authentication.

Device output through output device 206 provides feedback to the user by signaling distinct responses that have semantics associated with the patterns.

The training phase assumes the user has practiced forming a signature by performing a number of preliminary exercises to create a mental imprint of a preferred motion pattern. Kinematic input source 404 is on and in its initial state. The user conditions kinematic input source 404 to start the training of the signature by conveying the respective command, for example, a sequence {turn, knock, knock, knock} as mentioned previously. Kinematic input source 404 acknowledges entry to the training state by a respective response through output device 206. The user performs the trained signature, delimiting the signature events by defined start and stop commands. The device judges the strength of the presented gestures 406 based on probabilistic analysis of the kinematic motion pattern and signals acceptance or rejection to the user via a suitable response on output device 206. In case of rejection, the procedure starts over again.

The user repeats action of the signature until the device signals successful termination of its training algorithm via the respective response. Once the training phase has been completed, kinematic input source 404 enters normal state. The device can only be put back into the training state by the command used to initiate training, provided that the user has successfully authenticated.

In an authentication phase, kinematic input source 404 has successfully completed a training phase and is in normal state. The user turns on kinematic input source 404, which prompts the user for authentication by the respective response. The user performs the previously trained pattern or signature, delimiting apply gestures 406 with defined start and stop commands. Kinematic input source 404 receives receive gestures 408, creates signatures 410 and compares with stored patterns 412, to accept or reject the authentication request 402, and signals the decision to the user by the respective response though output device 206.

Once the authentication phase has been successfully completed, kinematic input source 404 enters operational state. Kinematic input source 404 returns to normal state, when the user turns it off.

A training calculation computes the running average xᵢ(t), yᵢ(t), zᵢ(t) and variance of the 3-D accelerations xᵢ(t), yᵢ(t), zᵢ(t) for the signatures Si, i=1, . . . , N performed by the user. Once the variance meets the desired level, the training algorithm stores the resulting final average x_{N}(t), y_{N}(t), z_{N}(t) and terminates. The variance provides a capability to accept a less than exact match of the input pattern with the stored pattern by defining an acceptance tolerance.

A verification computation computes a metric M based on the signature presented and the average signature stored, i.e., M=m(x(t), y(t), z(t), x_{N}(t), y_{N}(t), z_{N}(t)). If M meets the required condition, the signature is accepted; otherwise, it is rejected. The variable m is a suitably chosen function reflecting the difference or tolerance between presented and average signatures, as in the stored signatures.

During the training phase, a user provided a number N of kinematic patterns in three dimensions. Each of the provided patterns may be described by a trajectory xᵢ(t), yᵢ(t), zᵢ(t), i=0, . . . N−1. The set of N trajectories have been processed to yield a reference signature x_{N}(t), y_{N}(t), z_{N}(t). The verification process receives the current kinematic pattern of the user and compares the received pattern with the reference pattern (or signature) by computing the just described metric. If the metric M meets a predefined criterion, such as a threshold value of M<ε where ε is the threshold value, the kinematic pattern received is accepted as a valid match of the reference pattern or signature; otherwise the request is rejected.

In another illustrative embodiment, a Bluetooth® (an industry specification for very short distance wireless communication, obtained from Bluetooth SIG, Inc.) enabled component to kinematic input source 404, enabling kinematic input source 404 to be used as an authentication device for other devices such as a mobile computer, a mobile phone, and other portable devices. With this variation, a Bluetooth pairing has to be carried out initially and preferably as part of the training phase. Various pairing methods are possible, with one of the simplest being having a random number personal identification number (PIN) generated and programmed into each device at manufacturing time, and supplying that random number as part of the customer information to the end user.

Once paired, the personal identification number can be changed from the paired device and could optionally require the user to carry out the authentication signature to increase security. An authentication process would consist of the target device, such as the personal computer, searching for the authentication device, establishing a Bluetooth link, and waiting for a successful authentication over a certain amount of time. Alternatively, the authentication device could, once a successful authentication has been carried out, signal that the user authenticated successfully.

In another example, a wireless local area network (WLAN) enabled authentication device is used. In this case, a cryptographic certificate may be installed into the authentication device of kinematic input source 404. As part of the authentication device package, the user can either obtain a certificate from the manufacturer or have an existing certificate signed with the manufacturer key. The user can then install the manufacturer signed certificate into the computing device, such as a laptop computer. The laptop can then carry out a challenge and response protocol with the authenticator device, and establish a trusted and bonded relationship. Of course, the certificate approach can also be used for the Bluetooth example, or with any other wireless (or wired) technology.

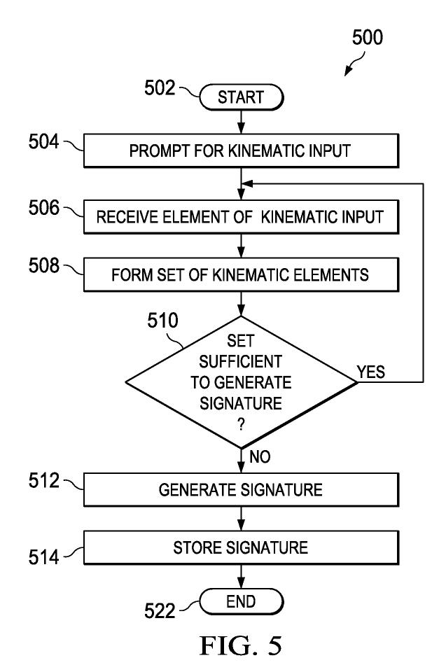

With reference to FIG. 5, a flowchart of a kinematic authentication training process, in accordance with illustrative embodiments is shown. Kinematic authentication training process 500 is an example of using kinematic authenticator 300 of FIG. 3.

Kinematic authentication training process 500 begins (step 502) and prompts for kinematic input (step 504). Input is received as a result of gestures or other actions of a requesting user. Responsive to the request, the authenticator receives elements of kinematic input (step 506). The input is collected to form a set of kinematic elements (step 508).

A determination is made as to whether there are sufficient kinematic elements in the set to generate a signature (step 510). When there are sufficient elements to generate a signature, a “yes” result is obtained. When there are not sufficient elements, a “no” result is obtained. When a “yes” is obtained in step 510, generate signature (step 512) is performed. Generate signature creates a signature from the kinematic elements. When a “no” is obtained in step 510, process 500 loops back to step 504. Store signature places the created signature in a pattern store for later use as a reference (step 514), with process 500 terminating thereafter (step 516).

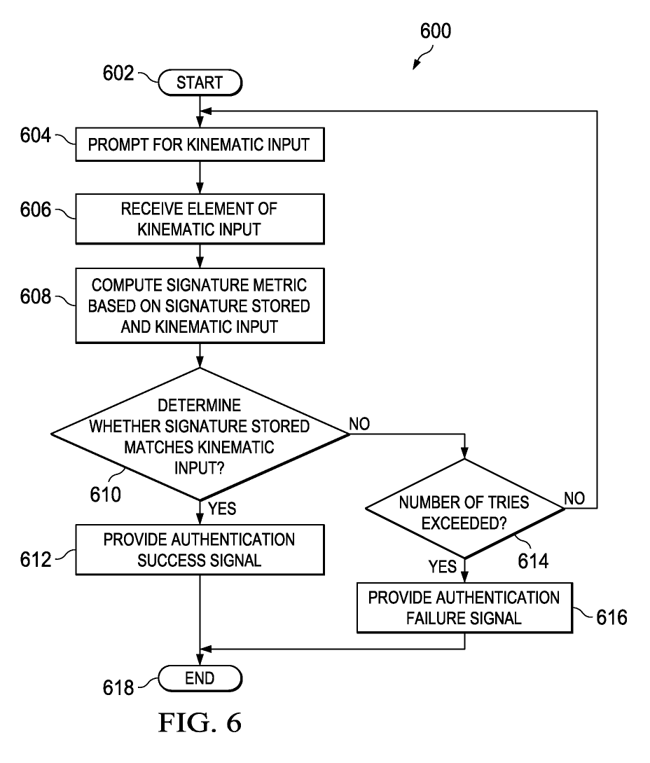

With reference to FIG. 6, a flowchart of a kinematic authentication process, in accordance with illustrative embodiments, is shown. Kinematic authentication process 600 is an example of using kinematic authenticator 300 of FIG. 3 in an authentication phase.

Kinematic authentication process 600 begins (step 602) and prompts for kinematic input (step 604). Input is received as a result of gestures or other actions of a requesting user. Responsive to the request, the authenticator receives elements of kinematic input (step 606).

Compute signature metric based on signature stored and kinematic input received from prompt 604 (step 608). Typically, a determination is made as to whether there are additional elements of the kinematic pattern to process, or if sufficient elements have been received to form a kinematic pattern from the set of received elements from which the computation may be made. The verification computation computes a metric M based on the signature presented and the average signature stored. Determine whether signature stored matches kinematic input (step 610). The match does not have to be an exact match, but within acceptable variance levels, as defined. When a match is found in step 610, a “yes” result is obtained. When no match is found in step 610, a “no” result is obtained. When a “yes” result is obtained in step 610, provide authentication success signal (step 612) is performed, with process 600 terminating thereafter (step 618). The signal provides tactile, visual or audio feedback to the requester.

When a “no” result is obtained in step 610, a determination is made as to whether a number of tries has been exceeded (step 614). If the requester has tried to authenticate too many times, a “yes” result is obtained. If the user has not exceeded the allowed number of attempts, a “no” result is obtained. When a “no” is obtained in step 614, the requester is permitted to try again, and process 600 loops back to step 604. When a “yes” is obtained in step 614, provide authentication failure signal (step 616) is performed and process 600 terminates.

In an illustrative embodiment, a computer implemented method prompts a user for a kinematic input, receives elements of kinematic patterns, collects the elements to form a kinematic pattern from the set of received elements, and computes a signature from the set of received elements. The computer-implemented method further determines whether the computed kinematic pattern of the signature matches a predetermined value of a stored kinematic signature. Responsive to a determination that the computed signature matches the predetermined value; the computer implemented method sends an authentication signal. The illustrative embodiment typically provides a capability to authenticate use of small footprint devices by kinematic-based input.

The flowchart and block diagrams in the figures illustrate the architecture, functionality, and operation of possible implementations of systems, methods and computer program products, according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention, the practical application, and to enable others of ordinary skill in the art to understand the invention for various embodiments, with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by, or in connection with, a computer or any instruction execution system. For the purposes of this description, a computer-usable or computer-readable medium can be any tangible apparatus that can contain, store, communicate, propagate, or transport the program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments, with various modifications as are suited to the particular use contemplated.

What is claimed is:

1. A computer implemented method for authentication by kinematic pattern match, the computer implemented method comprising:
prompting for a kinematic input;
receiving an element of a kinematic pattern to form a set of received elements;
determining whether there are additional elements of the kinematic pattern;
responsive to a determination that there are no additional elements of the kinematic pattern, forming the kinematic pattern from the set of received elements;
computing a signature from the set of received elements;
determining whether the signature matches a predetermined value; and
responsive to a determination that the signature matches a predetermined value, sending an authentication signal.
